(19) United States
(12) Patent Application Publication
(10) Pub. No.: US 2005/0065263 A1
(43) Pub. Date: Mar. 24, 2005

(54) Polycarbonate composition

(76) Inventors: James Y.J. Chung, Wexford, PA (US); Winfried G. Paul, Pittsburgh, PA (US)

Correspondence Address: BAYER MATERIAL SCIENCE LLC, 100 BAYER ROAD, PITTSBURGH, PA, 15205, US

(21) Appl. No.: 10/667,955

(22) Filed: Sep. 22, 2003

(51) Int. Cl. C08K 3/34

(52) U.S. Cl. 524/445

(57) ABSTRACT

A reinforced thermoplastic molding composition is disclosed. The composition contains polycarbonate resin, nanoclay in an amount of 0.1 to 20 percent relative to the weight of the polycarbonate and carboxylic acid in an amount of 1 to 20 percent relative to the weight of the nanoclay. The composition is characterized by its improved thermal stability and impact strength.

### FIELD OF THE INVENTION

The invention concerns thermoplastic molding compositions and more particularly, reinforced polycarbonate compositions.

### SUMMARY OF THE INVENTION

A reinforced thermoplastic molding composition is disclosed. The composition contains polycarbonate resin, nanoclay in an amount of 0.1 to 20 percent relative to the weight of the polycarbonate and carboxylic acid in an amount of 1 to 20 percent relative to the weight of the nanoclay. The composition is characterized by its improved thermal stability and impact strength.

### BACKGROUND OF THE INVENTION

Polycarbonate resins are well known and have long been used for a variety of applications because of their characteristic combination of good mechanical and physical properties. However, their stiffness (flexural modulus) is inadequate for certain structural applications such as housings for power tools. Glass fibers incorporated in polycarbonate have largely addressed this shortcoming yet have adversely effected the appearance of the molded parts.

Nanoclays, clays having particle size smaller than 100 nm, are commercially available. Their utility in polymeric matrices have been widely disclosed in the literature, e.g., J. Materials Res., 1993, Volume 8, page 1179; J. Polym. Sci., Part A: Polym. Chem., 1993, volume 31, page 2493. Nanocomposites are a class of materials which feature a phase having particle dimensions in the range 1 to 100 nm. The art has now recognized that the inclusion of these materials in polymeric matrices result in composites having better mechanical properties than do their counterparts that include micro- and macro- sized particles.

Among the presently relevant literature, mention may be made of the inclusion of C₁₆- and C₁₈-tributyl phosphonium exchanged montmorillonite in polycarbonate; Geralda Severe, Alex J. Hsieh and Bryan E. Koene, Society of Plastics Engineers, ANTEC 2000, page 1523. This disclosure included a reporting of the resulting degradation of the impact strength of the polycarbonate.

The art also recognizes that swelling agents, such as long-chain organic cations, and water-soluble oligomers or polymers can be intercalated or absorbed between adjacent layers of clay, and thus increase the interlayer spacing. U.S. Pat. No. 5,552,469 and WO 93/04117 among others, disclosed methods for treating relevant silicates resulting in imparting greater mechanical reinforcement to polymeric matrices in which they are incorporated.

U.S. Pat. No. 5,760,121 disclosed nanocomposites that contain a matrix polymer and exfoliated intercalates formed by contacting a phyllosilicate with a polymer to adsorb or intercalate the polymer between adjacent phyllosilicate platelets. Sufficient polymer is adsorbed between adjacent phyllosilicate platelets to expand the adjacent platelets to a spacing of 5 to 100 angstroms so that the intercalate easily can be exfoliated by mixing it with an organic solvent or a polymer melt. Also relevant are the disclosures in U.S. Pat. Nos. 5,747,560 and 5,385,776.

### DETAILED DESCRIPTION OF THE INVENTION

Suitable polycarbonate resins for preparing the copolymer of the present invention are homopolycarbonates and copolycarbonates and mixtures thereof.

The polycarbonates generally have a weight average molecular weight of 10,000 to 200,000, preferably 20,000 to 80,000 and their melt flow rate, per ASTM D-1238 at 300° C., is about 1 to about 65 g/10 min., preferably about 2 to 24 g/10 min. They may be prepared, for example, by the known diphasic interface process from a carbonic acid derivative such as phosgene and dihydroxy compounds by polycondensation (see German Offenlegungsschriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience Publishers, New York, N.Y., 1964, all incorporated herein by reference).

In the present context, dihydroxy compounds suitable for the preparation of the polycarbonates of the invention conform to the structural formulae (1) or (2). 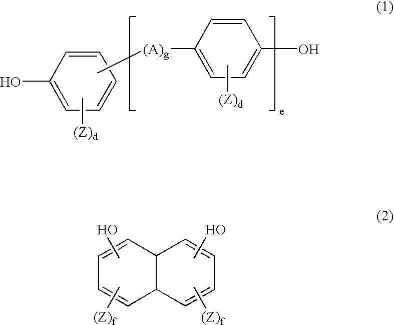
wherein

A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO₂ or a radical conforming to 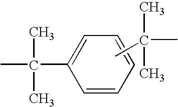
e and g both denote the number 0 to 1;

z denotes F, Cl, Br or C₁-C₄-alkyl and if several Z radicals are substituents in one aryl radical, they may be identical or different from one another;

d denotes an integer from 0 to 4; and

f denotes an integer from 0 to 3.

Among the dihydroxy compounds useful in the practice of the invention are hydroquinone, resorcinol, bis-(hydroxyphenyl)-alkanes, bis-(hydroxphenyl)-ethers, bis-(hydroxyphenyl)-ketones, bis-(hydroxyphenyl)-sulfoxides, bis-(hydroxyphenyl)-sulfides, bis-(hydroxyphenyl)-sulfones, dihydroxydiphenyl cycloalkanes, and α,α-bis-(hydroxyphenyl)-diisopropyl-benzenes, as well as their nuclear-alkylated compounds. These and further suitable aromatic dihydroxy compounds are described, for example, in U.S. Pat. Nos. 5,227,458; 5,105,004; 5,126,428; 5,109,076; 5,104,723; 5,086,157; 3,028,356; 2,999,835; 3,148,172; 2,991,273; 3,271,367; and 2,999,846, all incorporated herein by reference. Further examples of suitable bisphenols are 2,2-bis-(4-hydroxy-phenyl)-propane (bisphenol A), 2,4-bis-(4-hydroxyphenyl)-2-methyl-butane, 1,1-bis-(4-hydroxyphenyl) -cyclohexane, α,α′-bis-(4-hydroxy-phenyl)-p-diisopropylbenzene, 2,2-bis-(3-methyl-4-hydroxyphenyl)-propane, 2,2-bis-(3-chloro-4-hydroxyphenyl)-propane, bis-(3,5-dimethyl-4-hydroxyphenyl)-methane, 2,2-bis-(3,5-dimethyl4-hydroxyphenyl)-propane, bis-(3,5-dimethyl-4-hydroxyphenyl)-sulfide, bis-(3,5-dimethyl4-hydroxy-phenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, (α,α′-bis-(3,5-dimethyl-4-hydroxyphenyl) -p-diisopropylbenzene, 4,4′-sulfonyl diphenol and 4,4′-dihydroxydiphenyl.

Examples of particularly preferred aromatic bisphenols are 2,2,-bis-(4-hydroxyphenyl)-propane; 2,2-bis-(3,5-dimethyl-4-hydroxyphenyl)-propane; 1,1-bis-(4-hydroxyphenyl)-cyclohexane and 1,1 -bis-(4-hydroxyphenyl) -3,3,5-trimethylcyclohexane.

The most preferred bisphenol is 2,2-bis-(4-hydroxyphenyl)-propane (bisphenol A).

The polycarbonates of the invention may entail in their structure units derived from one or more of the suitable bisphenols.

Among the resins suitable in the practice of the invention is phenolphthalein-based polycarbonate, copolycarbonates and terpolycarbonates such as are described in U.S. Pat. Nos. 3,036,036 and 4,210,741, both incorporated by reference herein.

The polycarbonates of the invention may also be branched by condensing therein small quantities, e.g., 0.05 to 2.0 mol % (relative to the bisphenols) of polyhydroxy compounds.

Polycarbonates of this type have been described, for example, in German Offenlegungsschriften 1,570,533; 2,116,974 and 2,113,374; British Patents 885,442 and 1,079,821 and U.S. Pat. No. 3,544,514. The following are some examples of polyhydroxy compounds which may be used for this purpose: phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-(4,4′-dihydroxyphenyl)]-cyclohexyl-propane; 2,4-bis-(4-hydroxy-1-isopropylidine)-phenol; 2,6-bis-(2′-dihydroxy-5′-methylbenzyl)4-methyl-phenyol; 2,4-dihydroxybenzoic acid; 2-(4-hydroxyphenyl)-2-(2,4-dihydroxy-phenyl)-propane and 1,4-bis-(4,4′-dihydroxytriphenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in the incorporated herein by reference U.S. Pat. Nos. 3,028,365; 2,999,846; 3,153,008; and 2,991,273.

The preferred process for the preparation of polycarbonates is the interfacial polycondensation process.

Other methods of synthesis in forming the polycarbonates of the invention, such as disclosed in U.S. Pat. No. 3,912,688, incorporated herein by reference, may be used.

Suitable polycarbonate resins are available in commerce, for instance, Makrolon FCR, Makrolon 2600, Makrolon 2800 and Makrolon 3100, all of which are bisphenol based homopolycarbonate resins differing in terms of their respective molecular weights and characterized in that their melt flow indices (MFR) per ASTM D-1238 are about 16.5 to 24, 13 to 16, 7.5 to 13.0 and 3.5 to 6.5 g/10 min., respectively. These are products of Bayer Polymers LLC of Pittsburgh, Pa.

A polycarbonate resin suitable in the practice of the invention is known and its structure and methods of preparation have been disclosed, for example, in U.S. Pat. Nos. 3,030,331; 3,169,121; 3,395,119; 3,729,447; 4,255,556; 4,260,731; 4,369,303; 4,714,746; 5,470,938; 5,532,324 and 5,401,826 all of which are incorporated by reference herein.

Nanoclays are known and have been described in U.S. Pat. No. 5,747,560, which is incorporated herein by reference. Preferred clays non-exclusively include a natural or synthetic phyllosilicate such as montmorillonite, hectorite, vermiculite, beidilite, saponite, nontronite or synthetic flouromica, which have been cation exchanged with a suitable organoammonium salt or organophosphonium salt. A preferred clay comprises montmorillonite, hectorite or synthetic flouromica, more preferably montmorillonite or hectorite, and most preferably montmorillonite. The clay preferably has an average platelet thickness ranging from about 1 nm to about 100 nm, and an average length and average width each ranging from about 50 nm to about 700 nm.

The preferred nanoclays in the context of the present invention are natural montmorilloonite modified with any of a variety of quarternary ammonium salts and phosphonium salts. Such quarternary ammonium salts modified clays are commercially available from Southern Clay Products under Cloistite®. Most preferred nanoclays are Cloistite 20A and Cloistite 25A. Cloistite 20A is a natural montmorillonite modified with a quarternary ammonium salt of dimethyl, dihydrogenated tallow with a chloride as a counter anion. Cloisite 25A is a natural montmorillonite modified with a quaternary ammonium salt of dimethyl, hydrogenated tallow, 2-ethylhexyl with methyl sulfate as a counter ion.

Although the flexural modulus of composites containing polycarbonate and nanoclay is appreciably greater than that of the neat resin, a noticeable degradation, expressed in terms of the marked increase in melt flow rate and resultant decline of the impact properties, was noted to result upon extrusion compounding and molding.

Adding a carboxylic acid in small amount to polycarbonate/nanoclay composites was found to stabilize the composition. The carboxylic acid suitable in the present context includes both aliphatic and aromatic acids. Fatty acids, both saturated and unsaturated are included within the suitable acids. Preferably, the carboxylic acid is aliphatic and most preferably it contains 2 to 6 carbon atoms. Citric acid is advantageously used.

The acid is used in the practice of the invention in an amount of 1 to 20, preferably 5 to 15, more preferably 8 to 12 percent relative to the weight of the nanoclay.

The invention is further illustrated but is not intended to be limited by the following examples in which all parts and percentages are by weight unless otherwise specified.

### EXAMPLES

Compositions in accordance with the present invention were prepared and their properties evaluated. The polycarbonate that was used in these compositions was Makrolon 3208 polycarbonate resin (a bisphenol-A based homopolycarbonate having a melt flow rate (MFR) of about 5.1 g/10 min. per ASTM D 1238 at a loading of 1.2 kG at 300° C.), a product of Bayer Polymers LLC. The nanoclays designated in Tables 1 and 2 as “nanoclay 1 and 2 ” are, respectively, Cloistite 20A and 25A obtained commercially from Southern Clay Products. The citric acid that was used in the course of the experiments was chemically pure grade. The multi-axial impact strength was determined using an Instron instrumented impact tester with 3 in. stage and 0.5 in. tup at a dart speed of 15 mph. The thickness of all the aforementioned test specimens was ⅛″.

The preparation of these compositions and their testing were conventional; the properties are tabulated in Tables 1 and 2.

TABLE 1

| | 1 | 2 | 3 | 4 | 5 |
|---|---|---|---|---|---|
| Polycarbonate, wt. % | 100 | 97.5 | 95 | 97.5 | 95 |
| Nanoclay 1, wt. % | 0 | 2.5 | 5 | 0 | 0. |
| Nanoclay 2, wt. % | 0 | 0 | 0. | 2.5 | 5 |
| MFR (gm/10 min.) | 5.1 | 54.8 | 57.5 | 36.9 | 55.7 |
| Flexural Modulus | 3.62 | 4.07 | 4.42 | 3.99 | 4.54 |
| (psi × 10⁻⁵) | | | | | |
| Notched Izod Impact | 15.5 | 1 | 0.6 | 1.5 | 0.5 |
| Strength (ft-lb/in) | | | | | |
| Unnotched Izod Impact | N¹ | 57.1 | 13.5 | 64.1 | 13.4 |
| Strength (ft-lb) | | | | | |
| Multiaxial Impact | 60.6 | 27.6 | 2.3 | 39.7 | 2 |
| Strength (ft-lb) | | | | | |
| Fracture Mode² | D | S | B | S | B |

¹N denotes no break.
²D—ductile; S—shatter; B—brittle.

Examples 1-5 are comparative. The results show that the incorporation of nanoclay in polycarbonate resin resulted in the degradation of the impact properties.

TABLE 2

| | 6 | 7 | 8 | 9 |
|---|---|---|---|---|
| Polycarbonate, wt. % | 97.25 | 94.5 | 97.25 | 94.5 |
| Nanoclay 1, wt. % | 2.5 | 5 | 0 | 0 |
| Nanoclay 2, wt. % | 0 | 0 | 2.5 | 5 |
| Citric acid, wt. % | 0.25 | 0.5 | 0.25 | 0.5 |
| MFR (gm/10 min.) | 11.3 | 11.2 | 9.2 | 9 |
| Flexural Modulus | 4.0 | 4.6 | 4.2 | 4.6 |
| (psix 10⁻⁵) | | | | |
| Notched Izod | 3 | 2 | 1.7 | 1.3 |
| Impact Strength (ft-lb/in) | | | | |
| Unnotched Izod | N³ | N | N | N |
| Impact Strength (ft-lb) | | | | |
| Multiaxial Impact | 46.1 | 40.7 | 49 | 40.6 |
| Strength (ft-lb) | | | | |
| Fracture Mode | D⁴ | D* | D | D |

³N denotes no break
⁴D denotes ductile.
*out of the three samples tested one failed in ductile and two failed in brittle mode.

The results shown in Table 2 point to that the addition of citric acid to polycarbonate/clay nanocomposites imparts greater thermal stability, and improved impact properties.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A thermoplastic molding composition comprising a polycarbonate resin, nanoclay in an amount of 0.1 to 20 percent relative to the weight of the polycarbonate and about 1 to 20 percent relative to the weight of the nanoclay of a carboxylic acid, said nanoclay having an average platelet thickness ranging from about 1 to 100 nm, and an average length and average width each independently one of the other ranging from about 50 nm to about 700 nm.

2. The thermoplastic molding composition of claim 1, wherein the amount of the nanoclay is 0.1 to 15 percent.

3. The thermoplastic molding composition of claim 1, wherein the nanoclay is natural montmorilloonite modified with a quarternary ammonium salt or a quarternary phosphonium salt.

4. The thermoplastic molding composition of claim 3, wherein the quarternary ammonium salt is based on at least one member selected from the group consisting of dimethyl, dihydrogenated tallow with a chloride as a counter anion and dimethyl, hydrogenated tallow, 2-ethylhexyl with methyl sulfate as a counter ion.

5. The thermoplastic molding composition of claim 1, wherein the carboxylic acid is aliphatic.

6. The thermoplastic molding composition of claim 1, wherein the carboxylic acid is citric acid.

7. The thermoplastic molding composition of claim 1, wherein the amount of a carboxylic acid is 5 to 15 percent relative to the weight of the nanoclay.

8. The thermoplastic molding composition of claim 1, wherein the amount of a carboxylic acid is 8 to 12 percent relative to the weight of the nanoclay.

9. The thermoplastic molding composition of claim 1, wherein the nanoclay is a member selected from the group consisting of montmorillonite, hectorite and synthetic flouromica.

10. The thermoplastic molding composition of claim 9, wherein the nanoclay is montmorillonite.
